(19) United States
(12) Patent Application Publication
(10) Pub. No.: US 2026/0116101 A1
(43) Pub. Date: Apr. 30, 2026

(54) SHEET CONVEYANCE DEVICE AND IMAGE FORMING DEVICE

(71) Applicant: CANON KABUSHIKI KAISHA, Tokyo (JP)

(72) Inventor: JIANXUN XIE, Chiba (JP)

(21) Appl. No.: 19/359,481

(22) Filed: Oct. 15, 2025

(30) Foreign Application Priority Data
Oct. 25, 2024 (JP) 2024-187835
Aug. 21, 2025 (JP) 2025-137620

(51) Int. Cl. B41J 13/08; B41J 11/00; B41J 13/02; B41J 13/14

(52) U.S. Cl. CPC B41J 13/08; B41J 11/006; B41J 13/02; B41J 13/14

(57) ABSTRACT

A sheet conveyance device includes an upper unit fixed to a device body and including an upper conveyance guide forming a conveyance path, a lower unit arranged below the upper unit, including a lower conveyance guide forming the conveyance path with the upper conveyance guide, and rotatable downward relative to the upper unit, a biasing member having one end swingably supported by the lower unit and biasing the lower unit in a contracted state, and a moving member swingably supporting another end of the biasing member and moving the other end from a first position to a second position, wherein when the other end is at the first position, the biasing member has a first length, and when the other end is at the second position, the biasing member has a shorter second length, and the moving member is fixed with the other end at the second position.

### BACKGROUND

### Field of the Technology

The present disclosure relates to a technology for a sheet conveyance device that conveys a sheet and an image forming device that forms an image on the sheet.

### Description of the Related Art

In an image forming device, a portion of a sheet conveyance path is usually made openable and closable such that, in the event of a sheet jam, the sheet conveyance path can be opened and closed to remove the jammed sheet. In order to improve the operability of an opening/closing unit, it is known to use a biasing member to assist the opening and closing. Japanese Patent Laid-Open No. 2006-126594 describes a configuration in which an opening/closing unit is opened upward using a gas spring.

However, depending on the surrounding space and layout of the opening/closing unit, it may be useful to open the opening/closing portion downward. In order for the biasing member to apply force to the opening/closing unit when the opening/closing unit is closed, the biasing member may be compressed at the time of attachment to the opening/closing unit, which makes assembly difficult.

### SUMMARY

Accordingly, the present disclosure is directed to providing a sheet conveyance device that includes an opening/closing unit that is to be opened downward and enables easy assembly of a biasing member, and an image forming device.

According to some embodiments of the present disclosure, a sheet conveyance device includes an upper unit that is fixed to a device body and includes an upper conveyance guide that forms a conveyance path in which a sheet is to be conveyed, a lower unit that is arranged below the upper unit, includes a lower conveyance guide that, together with the upper conveyance guide, forms the conveyance path in which the sheet is to be conveyed, and is rotatable downward relative to the upper unit, a biasing member that has one end swingably supported by the lower unit and biases the lower unit in a contracted state, and a moving member that swingably supports another end of the biasing member and moves the other end from a first position to a second position, wherein when the other end is located at the first position, the biasing member has a first length, and when the other end is located at the second position, the biasing member has a second length shorter than the first length, and the moving member is fixed with the other end at the second position.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image forming system.

FIG. 2 is a perspective view of a sheet conveyance unit.

FIG. 3 is a cross-sectional view of the sheet conveyance unit taken along a plane parallel to a sheet conveyance direction.

FIG. 4 is a cross-sectional view of the sheet conveyance unit with a lower unit at a closed position.

FIG. 5 is a cross-sectional view of the sheet conveyance unit with the lower unit at an open position.

FIG. 6 is a cross-sectional view of the sheet conveyance unit during assembly of a gas spring.

FIG. 7 has an upper diagram illustrating a state in which a shaft attached to a second support member is located at a first position and a lower diagram illustrating a state in which the shaft attached to the second support member is located at a second position.

FIG. 8 is a cross-sectional view of the sheet conveyance unit before assembly of the gas spring.

### DESCRIPTION OF THE EMBODIMENTS

Hereinafter, various exemplary embodiments, features, and aspects of the present disclosure will be described with reference to the drawings. The embodiments described below are preferred embodiments of the present disclosure, and various technically preferable limitations are applied. However, the scope of the present disclosure is not unduly limited by the following description. Furthermore, not all of the configurations in the present embodiments described below are essential components of the present disclosure.

### First Embodiment

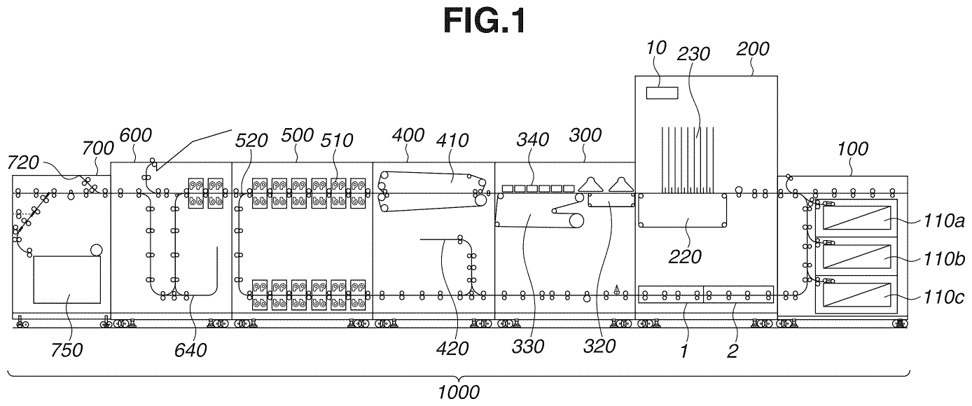

In the present embodiment, a case will be described in which an image forming system is applied to an inkjet recording system 1000. FIG. 1 is a schematic diagram illustrating an example of a general configuration of the inkjet recording system 1000. The inkjet recording system 1000 is a sheet-fed inkjet recording system that produces recorded matter by forming an ink image on a sheet using two liquids, namely, a reaction liquid and ink.

The inkjet recording system 1000 of the present embodiment is includes a combination of an image forming device and a plurality of sheet conveyance devices. In this description, devices that can stand on their own using underbody parts such as casters or adjusters and are independent in terms of their housings will be referred to as modules.

The inkjet recording system 1000 includes a paper feed module 100, a print module 200, a drying module 300, a fixing module 400, a cooling module 500, an reversing module 600, and an ejected sheet stacking module 700. A cut sheet supplied from the paper feed module 100 is conveyed along a conveyance path, processed in each module, and ejected to the ejected sheet stacking module 700 that serves as a sheet ejection device.

The paper feed module 100, which is an example of a sheet feeding device, has storages 110a, 110b, and 110c that store sheets. The storages 110a, 110b, and 110c are drawable toward the front of the device. Sheets are fed one by one from each of the storages 110a, 110b, and 110c by a separation belt and conveyance rollers (not illustrated) and conveyed to the print module 200. The number of storages 110a, 110b, and 110c is not limited to three, and may be one, two, four, or more.

The print module 200, which is an example of an image forming device that forms an image on a sheet, includes a pre-imaging registration correction unit (not illustrated), a print belt unit 220, and a recording unit 230. The sheet conveyed from the paper feed module 100 is corrected in tilt and position by the pre-imaging registration correction unit, and is conveyed to the print belt unit 220. The recording unit 230 is positioned so as to face the print belt unit 220 with the conveyance path therebetween. The recording unit 230 is a sheet processing unit that performs a recording process (printing) on the conveyed sheet from above using recording heads to form an image on the sheet. A plurality of recording heads is arranged along the conveyance direction. In the present embodiment, a total of five line-type recording heads are provided in correspondence with four colors of Y (yellow), M (magenta), C (cyan), and Bk (black), and a reaction liquid. The number of colors and recording heads is not limited to five.

As an inkjet method, a method using a heating element, a piezoelectric element, an electrostatic element, a microelectromechanical system (MEMS) element, or the like can be employed. Each color ink is supplied to the recording head from an ink tank (not illustrated) via an ink tube. The sheet printed by the recording unit 230 is adsorbed and conveyed by the print belt unit 220, thereby ensuring a clearance from the recording heads. The misalignment and color density of the image formed on the sheet printed by the recording unit 230 are detected by an inline scanner (not illustrated) arranged downstream of the recording unit 230 in the conveyance direction. The detection results are used to correct the printed image. In the present embodiment, the recording unit 230 is an example of an image forming unit.

The drying module 300 includes a decoupling unit 320, a drying belt unit 330, and a hot air blowing unit 340. The drying module 300 reduces the liquid components of the ink applied to the sheet by the recording unit 230 of the print module 200, thereby enhancing the fixation of the ink to the sheet. The sheet printed by the recording unit 230 of the print module 200 is conveyed to the decoupling unit 320 arranged in the drying module 300. The decoupling unit 320 can convey the sheet using air pressure from above and belt friction while weakly holding the sheet on the belt, thereby preventing displacement of the sheet on the print belt unit 220 where the ink image is formed. The drying belt unit 330 is positioned below the sheet being conveyed, and the hot air blowing unit 340 is positioned above the sheet being conveyed, and they face each other with the belt therebetween.

The sheet conveyed from the decoupling unit 320 is adsorbed and conveyed by the drying belt unit 330, and at the same time, the ink-applied surface of the sheet is dried by hot air from the hot air blowing unit 340. The drying method may be a combination of a method by which hot air is applied, a method by which the sheet surface is irradiated with electromagnetic waves (ultraviolet rays, infrared rays, or the like), and a conductive heat transfer method using contact with a heating element.

The fixing module 400 has a fixing belt unit 410. The fixing belt unit 410 has an upper belt unit and a lower belt unit, and the sheet conveyed from the drying module 300 passes between the heated upper belt unit and the lower belt unit, thereby fixing the ink to the sheet.

The cooling module 500 has a plurality of cooling units 510 to cool a high-temperature sheet conveyed from the fixing module 400. Each cooling unit 510 is configured to take outside air into a cooling box with a fan, increase the pressure inside the cooling box, and cool the sheet by blowing air onto the sheet from nozzles formed in the conveyance guide. The cooling units 510 are arranged both above and below the conveyance paths to cool the sheet from both sides.

The cooling module 500 also has a conveyance path switching unit 520, which can switch the sheet conveyance path depending on whether the sheet is conveyed to the reversing module 600 or to a duplex conveyance path used for duplex printing. During duplex printing, the sheet is conveyed to the conveyance path below the cooling module 500. In this case, the sheet is further conveyed from the cooling module 500 along the duplex conveyance path through the fixing module 400, the drying module 300, the print module 200, and the paper feed module 100. The duplex conveyance unit of the fixing module 400 is provided with a first reversing unit 420 that reverses a front side and a back side of the sheet. The sheet is then conveyed again to the pre-imaging registration correction unit, the print belt unit 220, and the recording unit 230 of the print module 200, where the sheet is printed by the recording unit 230.

The reversing module 600 has a second reversing unit 640, which can reverse a front side and a back side of the conveyed sheet, and can freely change the front and back sides of the ejected sheet.

The ejected sheet stacking module 700 has a top tray 720 and a stacking unit 750, and aligns and stacks the sheets conveyed from the reversing module 600.

The control unit 10 has a central processing unit (CPU), a random access memory (RAM), and a read only memory (ROM), and controls the components of the inkjet recording system 1000. The CPU outputs output signals to the electrical components to operate the electrical components at a desired timing and with a desired control amount, based on detection signals from sensors and information stored in the ROM. The ROM and the RAM store information data used to control each component, and the CPU reads data from the information stored in the ROM and writes data to the RAM. In the present embodiment, the control unit 10 may also control an external computer connected to the inkjet recording system 1000.

### Sheet Conveyance Units

Sheet conveyance units 1 and 2 are arranged on the duplex conveyance path below the print module 200. The sheet conveyance units 1 and 2 convey the sheets on which images have been formed by the image forming unit and conveyed, back toward the image forming unit.

The sheet conveyance units 1 and 2 are configured such that if a conveyed sheet jams, the sheet conveyance path can be opened to allow the user to remove the jammed sheet. In the present embodiment, the print belt unit 220 and others are arranged above the sheet conveyance units 1 and 2, so that there is not enough space where the upper unit of each sheet conveyance unit rotates upward relative to the lower unit. For this reason, the lower unit of the sheet conveyance unit is configured to rotate downward relative to the upper unit.

In the present embodiment, the sheet conveyance units 1 and 2 are different in the arrangement of rollers in the sheet conveyance direction and the unit width, but have the same configuration of the opening/closing mechanism. Accordingly, the opening/closing mechanism of each sheet conveyance unit will be described with reference to the sheet conveyance unit 2.

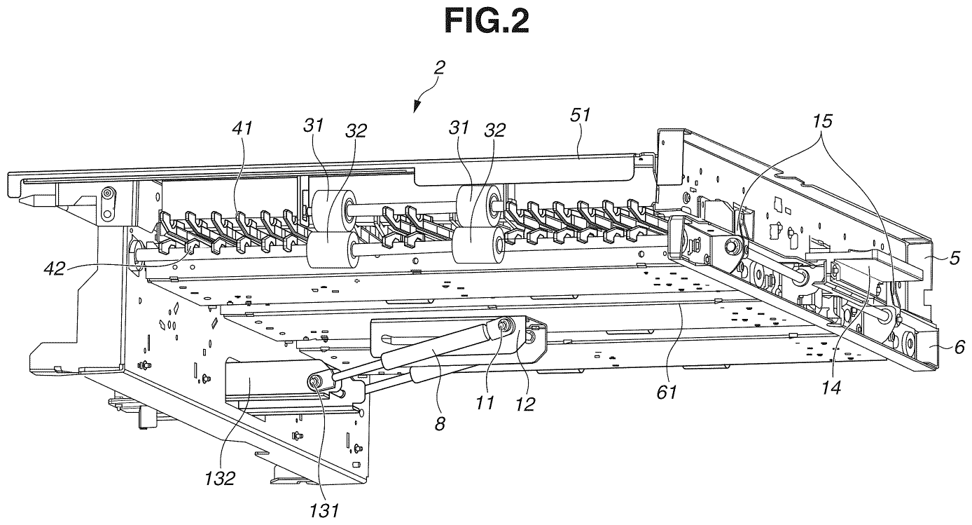

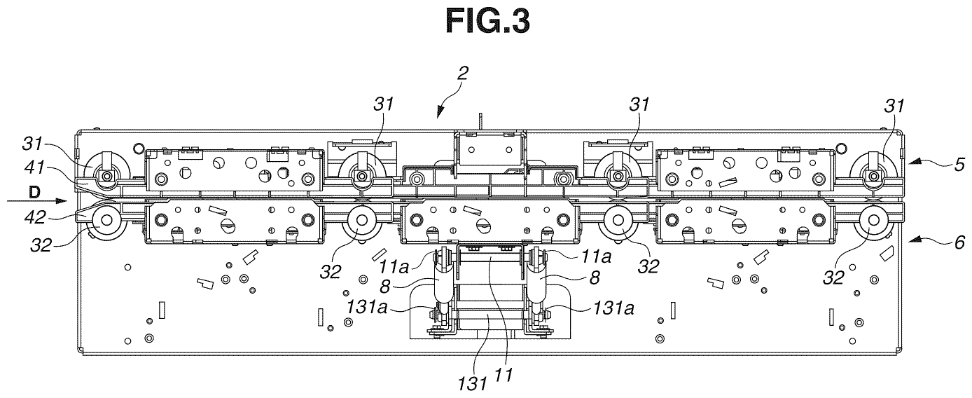

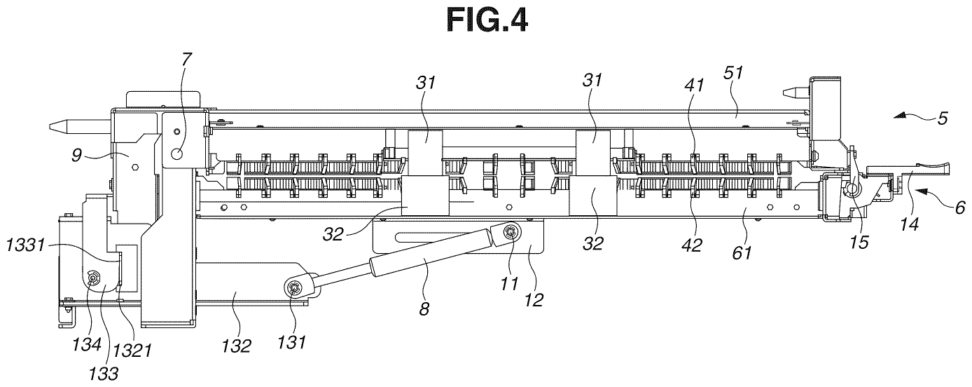

FIG. 2 is a perspective view of the sheet conveyance unit 2. FIG. 3 is a cross-sectional view of the sheet conveyance unit 2 parallel to the sheet conveyance direction. FIG. 4 is a cross-sectional view of the sheet conveyance unit 2 in a direction perpendicular to the conveyance direction, as seen from the upstream side in the sheet conveyance direction.

The sheet conveyance unit 2 includes an upper unit 5 fixed to the device body, and a lower unit 6 arranged below the upper unit 5. The sheet conveyance unit 2 further includes a gas spring 8, a first support member 12 that is fixed to the lower unit 6 and supports one end of the gas spring 8, a second support member 132 that supports the other end of the gas spring 8, and a cam lever 133 that moves the second support member 132.

The upper unit 5 includes an upper conveyance guide 41 that guides the sheet being conveyed, a plurality of upper conveyance rollers 31, and an upper frame 51 that supports the upper conveyance guide 41 and the upper conveyance rollers 31. The lower unit 6 includes a lower conveyance guide 42 that guides the sheet being conveyed, a plurality of lower conveyance rollers 32, and a lower frame 61 that supports the lower conveyance guide 42 and the lower conveyance rollers 32. When the sheet conveyance unit 2 is closed, the upper conveyance guide 41 and the lower conveyance guide 42 form a sheet conveyance path with predetermined spacing. As illustrated in FIG. 3, a plurality of upper conveyance rollers 31 and a plurality of lower conveyance rollers 32 are arranged in the sheet conveyance direction. The upper conveyance rollers 31 and the lower conveyance rollers 32 form conveyance roller pairs, and the sheet is nipped between the upper conveyance rollers 31 and the lower conveyance rollers 32 and is conveyed along a conveyance direction D.

In the present embodiment, the sheet conveyance unit 2 is large enough to convey B3-sized sheets. The frame 61 and others of the sheet conveyance unit 2 are made of sheet metal. For this reason, the sheet conveyance unit 2 is very heavy, and when a user opens or closes the sheet conveyance unit 2 to clear a jam, the heavy lower unit 6 may rotate forcefully to create a dangerous situation. In the present embodiment, the gas spring 8 biases the lower unit 6 of the sheet conveyance unit 2, thereby reducing the operating force the user may use to close the lower unit 6 and cushioning the momentum of the lower unit 6 being opened by the user.

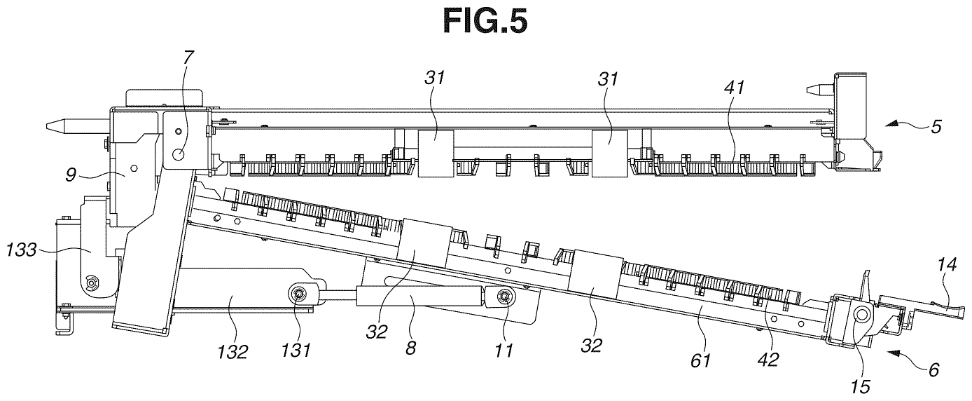

FIG. 4 is a cross-sectional view of the sheet conveyance unit 2 with the lower unit 6 at the closed position. FIG. 5 is a diagram illustrating the sheet conveyance unit 2 with the lower unit 6 at the open position. FIGS. 4 and 5 are cross-sectional views of the sheet conveyance unit 2 in a direction perpendicular to the sheet conveyance direction, as seen from the upstream side in the sheet conveyance direction.

One end of the gas spring 8 is swingably supported by the first support member 12 via a first shaft 11, and the other end of the gas spring 8 is swingably supported by the second support member 132 via a second shaft 131. In other words, the first shaft 11 couples one end of the gas spring 8 to the first support member 12, and the second shaft 131 couples the other end of the gas spring 8 to the second support member 132.

As illustrated in FIG. 3, the sheet conveyance unit 2 is provided with two gas springs 8 arranged parallel to the width direction of the sheet. E-shaped retaining rings 11a and 131a are provided at the ends of the first shaft 11 and the second shaft 131 as retaining members.

The lower unit 6 includes hooks 15 that are rotatable and hook the lower unit 6 onto the upper unit 5, and a grip portion 14 that is to be gripped by a user in clearing a jam. The hooks 15 and the grip portion 14 are arranged on the front side of the lower unit 6. In the present embodiment, the front side is the side on which a user stands in clearing a jam when the sheet conveyance unit 2 is attached to the device body (right side in FIG. 5). In the present embodiment, the back side is the side opposite to the side on which a user stands in clearing a jam (left side in FIG. 5).

The lower unit 6 illustrated in FIG. 4 is located at a position where the upper conveyance guide 41 and the lower conveyance guide 42 face each other and are parallel to each other, and where the upper conveyance rollers 31 and the lower conveyance rollers 32 nip and convey the sheet. In the present embodiment, this position will be defined as the closed position of the lower unit 6.

The lower unit 6 at the closed position illustrated in FIG. 4 is rotated downward about a rotation shaft 7, and the lower conveyance guide 42 and lower conveyance rollers 32 arranged in the lower unit 6 move away from the upper conveyance guide 41 and the upper conveyance rollers 31 arranged in the upper unit 5. This creates a predetermined space between the lower conveyance guide 42 and the upper conveyance guide 41 and between the lower conveyance rollers 32 and the upper conveyance rollers 31, allowing the user to remove the jammed sheet. This position will be defined as the open position of the lower unit 6.

In order to clear a jam, the user grips the grip portion 14 and rotates the hooks 15. Next, the user rotates the grip portion 14 downward to open the sheet conveyance path, whereby the user can clear the jam. After removing the jammed sheet, the user grips the grip portion 14 and rotates the lower unit 6 upward to turn the lower unit 6 to the closed position, and then hooks the hooks 15 onto the upper unit 5 again. In the present embodiment, the lower unit 6 can be stopped at any position between the open position and the closed position.

The gas spring 8 biases the lower unit 6 in the direction of rotating and closing the lower unit 6 from the open position to the closed position. This reduces the operating force the user may use to close the lower unit 6 from the open position to the closed position, and also cushions the momentum of the lower unit 6 being opened from the closed position to the open position.

### Support Mechanism of Gas Spring

In the present embodiment, the lower unit 6 of each sheet conveyance unit is configured to rotate downward relative to the upper unit 5. In the opening/closing unit that is to be opened downward, a large force may be used to compress the gas spring 8 at the time of attaching the gas spring 8, which makes assembly difficult.

In the present embodiment, the rotation shaft 7 is arranged on the back side of the sheet conveyance unit 2 and outside of the sheet conveyance path. The upper unit 5 has a back frame 9 fixed to the upper frame 51. The back frame 9 is arranged on the back side of the sheet conveyance unit 2 and below the upper frame 51, and has a shaft 134. The gas spring 8 erects the back frame 9 and the lower frame 61 of the lower unit 6 via the first support member 12 and the second support member 132.

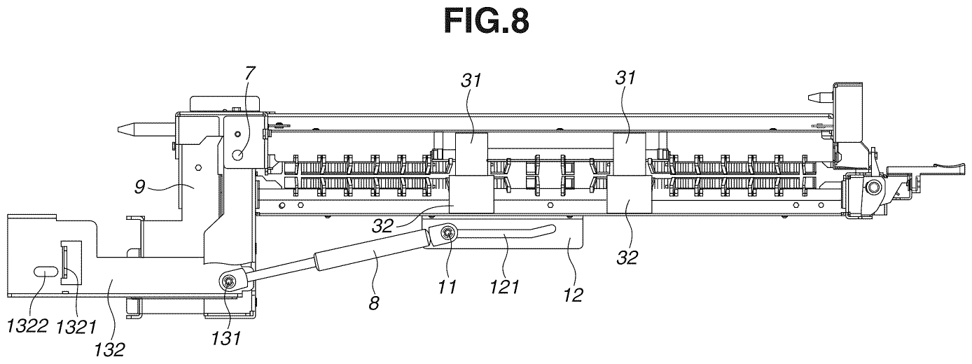

The cam lever 133 has a cam surface 1331 that comes into contact with a contact portion 1321 (described below) of the second support member 132. The cam lever 133 is pivotally supported by the shaft 134 of the back frame 9 and rotates about the shaft 134. The second support member 132 has the contact portion 1321 that comes into contact with the cam surface 1331 and an opening 1322 (FIG. 8). The opening 1322 extends along the sheet width direction, and the shaft 134 passes through the opening 1322. That is, the shaft 134 passes through the back frame 9, the opening 1322 of the second support member, and the cam lever 133. Accordingly, when the gas spring is assembled, the cam surface 1331 of the cam lever 133 comes into contact with and presses against the contact portion 1321 of the second support member 132, whereby the second support member 132 can slide in the sheet width direction.

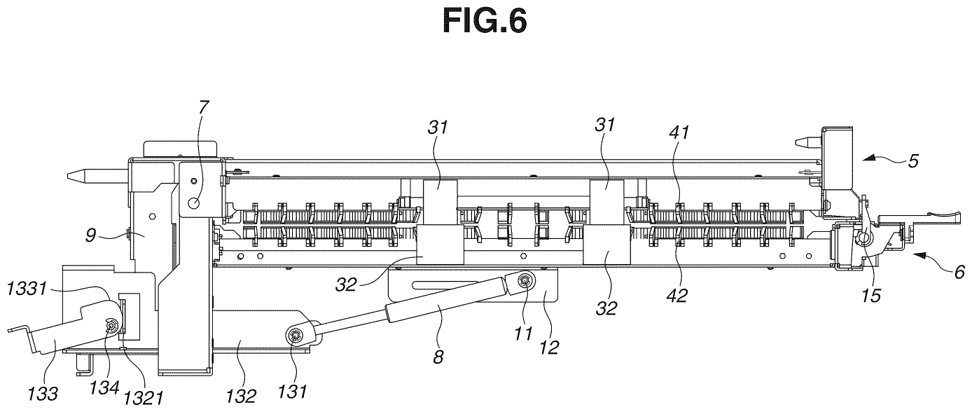

Next, a method for assembling the gas spring 8 will be described. FIG. 6 illustrates the state of the gas spring 8 during assembly. FIG. 4 illustrates the state of the gas spring 8 after assembly. In the present embodiment, the gas spring 8 is in an uncompressed state during assembly, and is in a compressed state after assembly.

As illustrated in FIG. 6, when the gas spring 8 is being assembled, the stroke of the gas spring 8 is zero at which no reaction force is generated. The position of the second shaft 131 in this state will be defined as a first position. From this state, the user rotates the cam lever 133 upward. As the cam lever rotates by a predetermined angle, the cam surface 1331 is pressed against the contact portion 1321 of the second support member 132, causing the second support member 132 to slide in the sheet width direction. As the second support member 132 slides due to the cam lever 133, the gas spring 8 is compressed to a predetermined stroke. The position of the second shaft 131 in this state will be defined as a second position. In other words, as the cam lever 133 rotates by a predetermined angle, the second shaft 131 of the second support member 132 slides from the first position to the second position via the cam surface 1331 and is fixed at the second position. In this manner, as the second shaft 131 moves from the first position to the second position, the gas spring 8 is compressed to a predetermined stroke, and the repulsive force of the gas spring 8 holds the lower unit 6 at the closed position.

In the present embodiment, the gas spring 8 is an example of a biasing member, and the second support member 132 is an example of a moving member. However, in the present embodiment, the cam surface 1331 is pressed against the contact portion 1321 of the second support member 132, causing the second support member 132 to move and compress the gas spring 8. However, the present disclosure is not limited to this configuration. The other end of the gas spring 8 may be swingably supported by the cam lever 133 via the second shaft 131, and the gas spring 8 may be compressed by rotation of the cam lever 133.

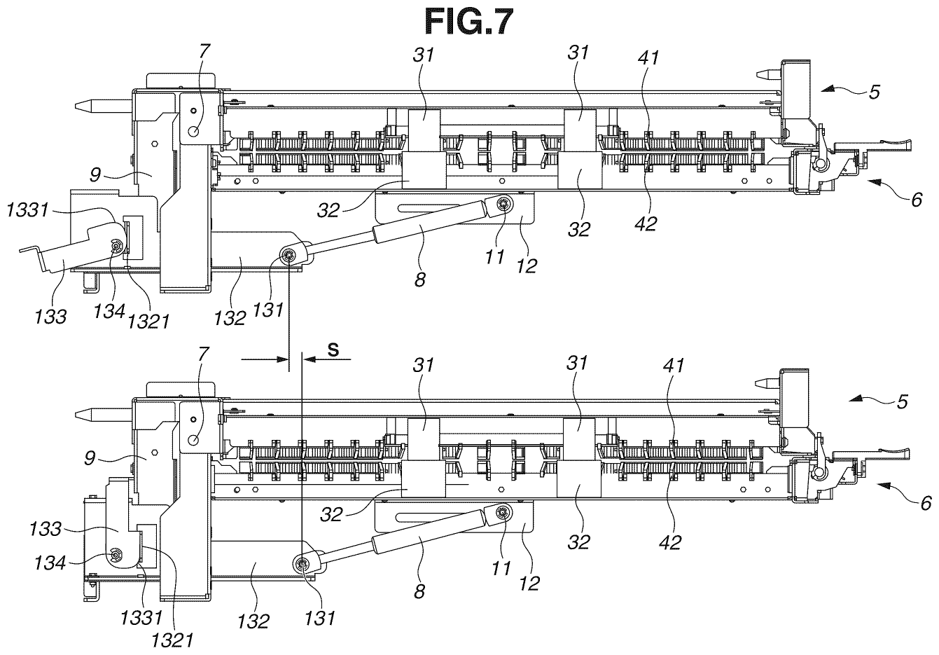

FIG. 7 has diagrams illustrating the movement of the second shaft 131, in which the state of the second shaft 131 at the first position during assembly of the gas spring 8 (FIG. 6) and the state of the second shaft 131 at the second position after assembly of the gas spring 8 (FIG. 4) are arranged vertically. Rotating the cam lever 133 moves the second shaft 131 a distance S from the first position to the second position. This compresses the gas spring 8, supporting the lower unit 6 at the closed position. The first shaft 11 is located at the rightmost position in a slit 121 in the first support member 12 (FIG. 7) during assembly of the gas spring 8 illustrated in FIG. 6 and after assembly of the gas spring 8 illustrated in FIG. 4.

In the present embodiment, the cam surface 1331 has a curved portion and a straight portion. Specifically, when the second support member 132 is at the first position, the curved portion of the cam surface 1331 is in contact with the contact portion 1321, and when the second support member 132 is at the second position, the straight portion of the cam surface 1331 is in contact with the contact portion 1321. In this manner, when the second support member 132 is at the second position, the straight portion of the cam surface 1331 is in contact with the straight-line contact portion 1321, thereby fixing the position of the second support member 132. That is, the cam lever 133 functions as a fixing unit that fixes the second support member 132 at the second position. However, the present disclosure is not limited to this configuration. The back frame 9 and the second support member 132 may be fixed by a fastening member when the second support member 132 is at the second position.

When the lower unit 6 is opened downward, the second shaft 131 remains at the second position. For this reason, when the lower unit 6 is opened downward, as the first shaft 11 rotates around the rotation shaft 7, the gas spring 8 is gradually compressed and its repulsive force increases. This prevents the lower unit 6 from opening unexpectedly due to its own weight, such that the lower unit 6 can be opened safely.

FIG. 8 illustrates the state before assembly of the gas spring 8 illustrated in FIG. 6. In the present embodiment, the gas spring 8 is attached in the state illustrated in FIG. 8. The slit 121 in the first support member 12 extends along the sheet width direction. The slit 121 guides the first shaft 11, which supports one end of the gas spring 8, from the outside to the center in the sheet width direction.

As illustrated in FIG. 8, before assembly of the gas spring 8, the shaft 11 is to be attached to the slit 121 of the first support member 12 and one end of the gas spring 8, and the shaft 131 is to be attached to the second support member 132 and the other end of the gas spring 8. After the attachment of the shaft 11 and the shaft 131, the gas spring 8 and the second support member 132 are slid along the slit 121. Then, as illustrated in FIG. 6, the cam lever 133 is to be attached with the second support member 132 at the first position. That is, the gas spring 8 is attached when the second support member 132 is closer to the back frame 9 than the first position in the sheet width direction. At this time, the gas spring 8 is not compressed.

Since the slit 121 extends along the sheet width direction, the gas spring 8 and the second support member 132 can be inserted from the back side to the front side of the sheet conveyance unit 2, allowing easy attachment. However, instead of providing the slit 121 in the first support member 12, a hole may be provided in the first support member 12 at the position where the first shaft 11 is located as illustrated in FIG. 6. In other words, the gas spring 8 may be attached with the second support member 132 at the first position.

The downward-opening sheet conveyance unit 2 of the present embodiment has the gas spring 8. Accordingly, at the time of closing the opening/closing unit, the user can easily obtain an operating force against the reaction force of the unit's weight and roller pressure, and can perform the operation comfortably. Furthermore, the gas spring 8 prevents the lower unit 6 from suddenly opening due to an unexpected opening of the opening/closing unit, allowing the user to perform the operation more safely with improvement in usability. In addition, no special tools are required to attach or assemble the gas spring 8 that assists in opening and closing the unit in the present embodiment, allowing easy attachment and assembly with ease of maintenance.

In the above-described embodiment, the image forming system is applied to the inkjet recording system 1000 of the inkjet recording type. However, the present disclosure is not limited to this application, and the image forming system may be applied to an electrophotographic image forming system.

In the present embodiment, a gas spring is used as the biasing member, but the present disclosure is not limited to this example. For example, a spring may be used as the biasing member.

In the present embodiment, the first position is a position at which the stroke of the gas spring 8 is zero. However, the present disclosure is not limited to this example, and the stroke of the gas spring 8 may occur at the first position. In other words, the first position is not limited to a position at which no reaction force of the biasing member is generated, and the reaction force of the biasing member may be generated at the first position. That is, when the other end of the biasing member is located at the first position, the length of the biasing member is a first length, and when the other end is located at the second position, the biasing member has a second length that is shorter than the first length, and the moving member is fixed when the other end is located at the second position. The length of the biasing member is a distance from one end to the other end of the biasing member.

That is, when the other end of the biasing member is located at the first position, the amount of contraction of the biasing member is a first amount of contraction, and when the other end of the biasing member is located at the second position, the amount of contraction of the biasing member is a second amount of contraction that is greater than the first amount of contraction, and the moving member is fixed when the other end is located at the second position.

According to the present disclosure, it is possible to easily assemble a gas spring to an opening/closing unit that is opened downward.

While the present disclosure has been described with reference to various exemplary embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-187835, filed Oct. 25, 2024, and No. 2025-137620, filed Aug. 21, 2025, which are hereby incorporated by reference herein in their entireties.

What is claimed is:

1. A sheet conveyance device comprising:
an upper unit that is fixed to a device body and includes an upper conveyance guide that forms a conveyance path in which a sheet is to be conveyed;
a lower unit that is arranged below the upper unit, includes a lower conveyance guide that, together with the upper conveyance guide, forms the conveyance path in which the sheet is to be conveyed, and is rotatable downward relative to the upper unit;
a biasing member that has one end swingably supported by the lower unit and biases the lower unit in a contracted state; and
a moving member that swingably supports another end of the biasing member and moves the other end from a first position to a second position,
wherein when the other end is located at the first position, the biasing member has a first length, and when the other end is located at the second position, the biasing member has a second length shorter than the first length, and the moving member is fixed with the other end at the second position.

2. The sheet conveyance device according to claim 1,
wherein the biasing member is a gas spring, and
wherein when the other end is at the second position, the gas spring biases the lower unit in a closing direction and supports the lower unit, and when the lower unit is rotated from a closed position to an open position, the gas spring cushions momentum of the lower unit being opened.

3. The sheet conveyance device according to claim 1, wherein the other end of the biasing member is arranged below the lower unit.

4. The sheet conveyance device according to claim 1, further comprising a cam that comes into contact with the moving member and is rotatable,
wherein when the cam rotates, the other end moves from the first position to the second position.

5. The sheet conveyance device according to claim 4, wherein the cam includes a lever portion to be gripped by a user.

6. The sheet conveyance device according to claim 4,
wherein the cam has a curved portion and a straight portion,
wherein when the cam rotates with the curved portion of the cam in contact with the moving member, the other end moves from the first position toward the second position, and
wherein when the straight portion of the cam comes into contact with the moving member, the other end is fixed at the second position.

7. The sheet conveyance device according to claim 1,
wherein the upper unit includes the upper conveyance guide and an upper conveyance roller,
wherein the lower unit includes the lower conveyance guide and a lower conveyance roller, and
wherein when the lower unit is at the closed position, the sheet to be conveyed is conveyed while being nipped between the upper conveyance roller and the lower conveyance roller.

8. The sheet conveyance device according to claim 1, further comprising a back frame that is fixed to the upper unit and arranged on a back side of the device body,
wherein the moving member moves in a sheet width direction relative to the back frame.

9. The sheet conveyance device according to claim 1, further comprising a retainer that is attached to an end of a shaft that couples the other end of the biasing member to the moving member and swingably supports the biasing member,
wherein the retainer is attached with the other end at the first position.

10. The sheet conveyance device according to claim 1,
wherein the lower unit has a support member that swingably supports the one end of the biasing member,
wherein the support member includes a slit extending along the sheet width direction, and
wherein the slit guides the one end of the biasing member from outside to a center in the sheet width direction.

11. The sheet conveyance device according to claim 1, wherein the lower unit includes a grip portion that is to be gripped by a user when opening or closing the lower unit.

12. The sheet conveyance device according to claim 1, wherein the sheet conveyance device is arranged on a duplex conveyance path for conveying a sheet on which an image has been formed by an image forming unit configured to form an image on a sheet, back to the image forming unit.

13. An image forming device comprising:
the sheet conveyance device according to claim 1; and
an image forming unit configured to form an image on a sheet.
